(19) United States
(12) Patent Application Publication
(10) Pub. No.: US 2008/0009277 A1
(43) Pub. Date: Jan. 10, 2008

(54) Method and system for synchronization of mobile phones

(76) Inventor: Brian Bidwell, Little Rock, AR (US)

Correspondence Address: Steven Thrasher, 391 Sandhill Dr., Richardson, TX, 75080, US

(21) Appl. No.: 11/482,432

(22) Filed: Jul. 7, 2006

(51) Int. Cl. H04M 3/00

(52) U.S. Cl. 455/418

(57) ABSTRACT

The invention is a method and system for the synchronization of calendar entries that includes calendar entries stored on POMP. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### TECHNICAL FIELD OF THE INVENTION

The present invention relates generally to computer software, and more particularly to the synchronization of data between a computer and a mobile phone.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### DISCUSSION

As cell phone (as opposed to the much more functional but expensive “smart phones”) technology improves, they are becoming increasingly important personal management devices. Many of these devices provide calendar, tasks, contacts, and other database related functions. Despite this proliferation users of such devices are often caught without information they need, when they need it. Therefore, a need has arisen for a solution that provides calendar synchronization of cell phones in an efficient, reliable manner. The described invention provides such a solution.

Computing devices may store data in more than one memory location. When the same or related information is stored in two locations, it is possible for the data to change in one location (or “store”) and not in another. To solve this problem, synchronization methods have been developed to propagate the changes between the different stores, so that the information in the different stores “correlate to each other,” so that the most recent or reliable information is stored in both stores.

However, none of the methods of synchronization correlate data in a manner that reliably stores the right data in the right data fields. The disclosed invention also solves this problem.

### BRIEF DESCRIPTION OF THE DRAWINGS

Various aspects of the invention, as well as an embodiment, are better understood by reference to the following detailed description. To better understand the invention, the detailed description should be read in conjunction with the drawings, in which like numerals represent like elements unless otherwise stated.

FIG. 1 is a functional block diagram of one exemplary synchronization system as implemented using a computing device and a POMP.

FIG. 2 shows an architectural overview of the calendar synchronization software application.

FIG. 3 illustrates an algorithm that enables synchronization of a handheld device.

FIG. 4 is an algorithm to find changes required to bring entries up to date.

FIG. 5 illustrates an algorithm that may be used to process changes to a remote data store.

### EXEMPLARY EMBODIMENT OF A BEST MODE

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Some methods of the invention may be practiced by placing the invention on a computer-readable medium and/or in a data storage (“data store”) either locally or on a remote computing platform, such as an application service provider, for example. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to transport the invention. It should be noted in the following discussion that acts with like names are performed in like manners, unless otherwise stated.

Of course, the foregoing discussions and definitions are provided for clarification purposes and are not limiting. Words and phrases are to be given their ordinary plain meaning unless indicated otherwise.

### Description of the Drawings

As a preliminary matter, in the exemplary embodiment of the invention, the target handheld device is not a smart phone, which is typically identified as a mobile phone that encapsulates a computing operating system (usually graphic-driven as opposed to merely menu-driven). Thus, the invention can be characterized as syncing a computer database with a plain old mobile phone (POMP), or, in other words, a “non-smart” phone. As used herein, POMP includes push-type pagers and other “dumb” pagers. While the definition of a non-smart phone vary, one of ordinary skill in the art can easily distinguish between a smart and plain old mobile phone/non-smart phone. The more limited functionality of a POMP versus a smart phone defines the two as non-analogous areas of art.

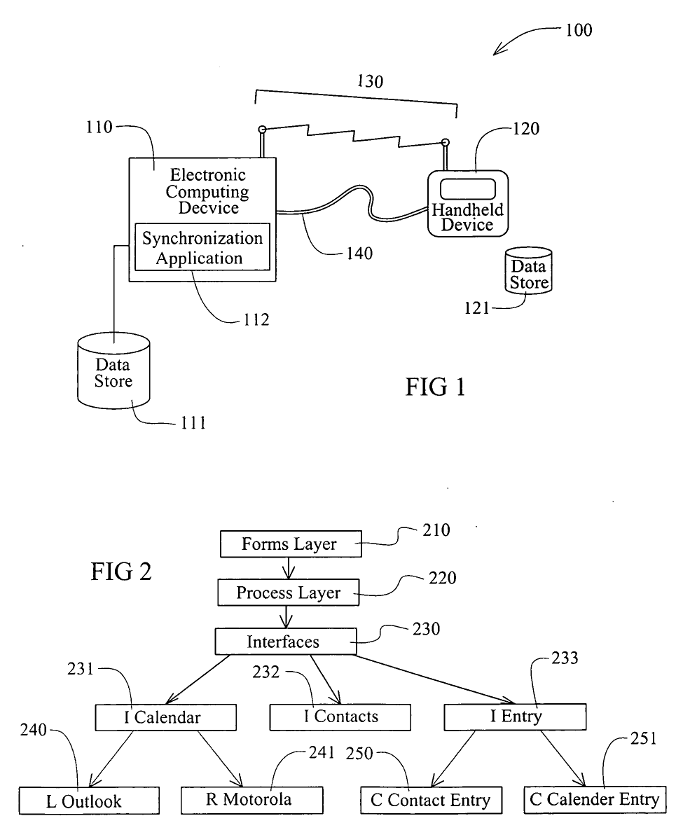

FIG. 1 is a functional block diagram of one exemplary synchronization system 100 as may be implemented using an electronic computing device 110 which may be a PC, laptop, smart phone, or other computing platform, and a POMP 120. The computing device 110 provides means for performing actions, such as calendar functions. The computing device 110 also has at least one data store 111 attached suitable for storing calendar data. Of course, a great many types of computing devices and POMPs are known, and all those known, unknown, foreseeable and unforeseeable are incorporated within the scope of the invention.

The data store 111 is defined in the present embodiment as being a “local data store 111” to distinguish it from other data stores, rather than implying any functional or structural limitation. Furthermore, the computing device 110 comprises a communications pathway 130 for data transmission between the computing device 110 and other devices.

The communications pathway may be wireless 120 or wired 140. The POMP 120 may be any cell phone, pager, and is sometimes called a mobile device, or the like, by various manufacturers. In fact, a single user may have several different POMPs capable of implementing the invention. The POMP 120 comprises at least one data store 121, which stores contact-calendar data. The data store 121 is referred to as the “remote data store 121” to distinguish it from other data stores. Accordingly, the synchronization system 100 is implemented as a synchronization application 112, which executes program code on the computing device 110 to transmit selective data to and from the handheld device 120.

FIG. 2 shows an architectural overview (a “class diagram”) of the calendar synchronization software application, using object-oriented design. Of course, it is appreciated by those of skill in the programming arts that the class diagram is a simplification of a system and includes a selected subset of the classes and interfaces needed to implement a system. The topmost layer is the forms layer 210. The forms layer 210 handles user interaction with the application 112. When a user performs an action that requires processing, such as requesting synchronization of a calendar, the forms layer 210 passes program control to the process layer 220.

The process layer 220 performs high-level business logic required to perform a selected or desired action. The business logic coordinates lower-level objects through software interfaces 230. One such interface is the IContacts interface 232, which represents data comprising an address book. Another interface is the ICalendar interface 231, which provides a generic abstraction of a calendar. Example classes that implement this interface are LOutlook 240, which represents a “local” Microsoft® Outlook® calendar, and RMotorola 241, which encapsulates a “remote” Motorola® calendar stored on a POMP such as a cell phone. Similarly, the CContactEntry 250 and CCalendarEntry 251 classes implement a generic lEntry 233 interface.

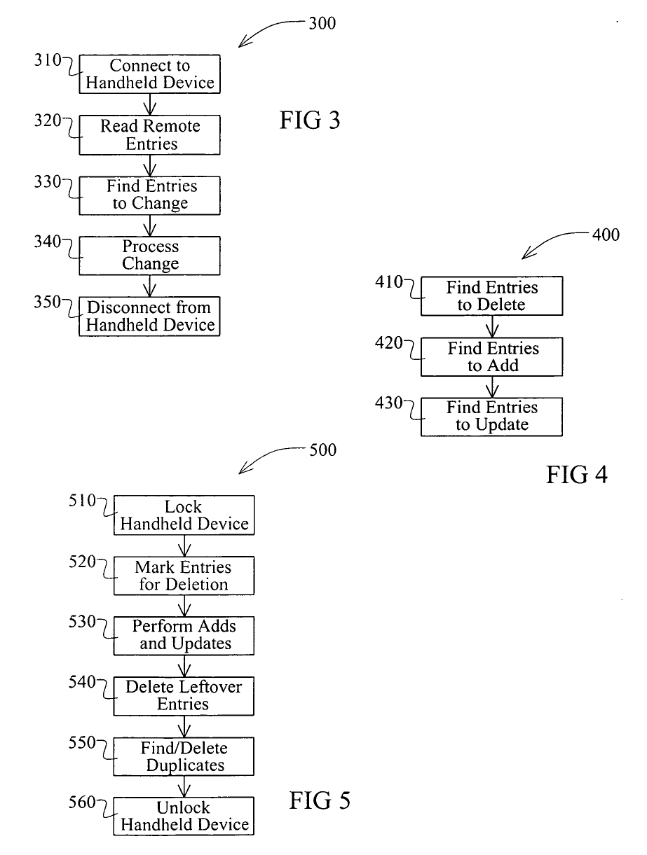

FIG. 3 illustrates one embodiment of a synchronization algorithm 300, being an algorithm that enables synchronization of a POMP with a computing device. First, in a connection act 310, the synchronization application 112 executing on the computing device establishes a connection with a POMP. Next, in a retrieve entries act 320, the application attempts to retrieve the calendar entries from the POMP. The application 112 may request all entries from the device, or a subset of entries that may be predefined or user-selected, such as entries limited by date range or other criteria, and may depend on the capabilities of the POMP command set.

In the retrieve entries act 320, each calendar entry retrieved from the POMP is “inspected” by the application 112 for a synchronization indicator (or “flag”). In one embodiment of the invention, the indicator consists of the three-character sequence [B] (open square-bracket, capital B, close square-bracket) appended to the end of the Title field of the calendar entry to flag that entry. Of course, many other types of indicator could be used and are readily recognized by those of skill in the art upon reading the present disclosure. For example, the indicator could be a bit(s), float, integer, or any combination of characters.

Flags are indicators computer programs use to designate either a “state” of an event, or a “status” of a datum. Their use in this embodiment involves using the computing device-based data as a data anchor (meaning that it is assumed that the information on the computing device is always correct). Those calendar entries form the POMP that have the appropriate synchronization indicator are marked in memory with the “CreatedByApp” flag. This flag is used throughout the synchronization process. Once calendar entry retrieval is successful, the application 112 passes control to the find entries to change code block, as a find entries act 330.

“Flagged” entries may require data changes or modifications so that entries are usable by the device receiving the entries. The table below shows how the “CreatedByApp” flag gets set based upon calendar data retrieved from the POMP.

| Handheld entry has | |
|---|---|
| synchronization indicator? | Created By App Flag |
| Yes | Yes |
| No | No |

The algorithm will later use the “CreatedByApp” flag to facilitate identifying necessary changes to the remote calendar. One necessary change occurs when the user adds one or more new entries to the local calendar. The local entries need to be propagated to the POMP during synchronization.

Then, after the necessary changes are identified the application begins the process changes algorithm in a change act 340. In the previous example of a new entry being added to the local calendar, the application will identify the entry as an “add” and the entry will be sent to the POMP with the synchronization indicator embedded within the entry.

The following table summaries how the “CreatedByApp” flag affects modification of calendar entries on the POMP.

| Entry | Entry | Handheld | |
|---|---|---|---|
| exists in | exists in | entry | |
| local | remote | created by | Modification to remote |
| calendar | calendar | app flag? | data |
| Yes | No | N/A | Add entry, include |
| | | | synchronization |
| | | | indicator |
| No | Yes | No | No change, leave entry |
| | | | as is |
| Yes | Yes | No | Update entry to include |
| | | | the synchronization |
| | | | indicator |
| No | Yes | Yes | Delete entry from |
| | | | handheld |
| Yes | Yes | Yes | No change, leave entry |
| | | | as is |

Then, in a disconnection act 350, the application will disconnect from the handheld device. An exemplary change process is discussed below with reference to FIG. 4.

FIG. 4 is a find entries algorithm 400, which finds changes required to bring entries up to date. The find entries algorithm 400 is one alternative embodiment of a process described above as the find entries act 330. The find entries algorithm 400 keeps a list (in memory) of the POMP calendar entries (“EntriesToChange”) and a corresponding action (delete, add, update, or none) to be applied in a later act. The list could be implemented with any number of data structures such as a linked list, array, table, map, or other implementation as will be readily apparent to those of skill in the software arts upon reading this disclosure. Initially, the entries are set to an action of “none” so that those that have not changed will be left unchanged.

First, in a find entries to delete act 410, the algorithm finds entries to delete. Accordingly, the algorithm scans the calendar entries retrieved from the POMP. Any entries marked with the “CreatedByApp” flag in act 320 that no longer have a match in the local data store 111 should be deleted. Therefore, the entry is set to an action of delete and is added to the EntriesToChange list. Any items without the “CreatedByApp” flag can be assumed to have been created outside of the synchronization process and will not be deleted.

Next, in a find entries to add act 420 the algorithm finds entries to add. Thus, the algorithm scans the calendar entries in the local data store. For each entry that is not found in the handheld device's calendar, an action of add will be specified and the entry will be added to the EntriesToChange list. Also, the entry will be marked with the “CreatedByApp” flag, since it was created during the synchronization process. Finally, in a find entries to update act 430, the algorithm finds entries to update. To do this, the algorithm scans all calendar entries retrieved from the POMP. Any entries which have neither been marked as “CreatedByApp” nor marked for deletion, but which have a match in the local calendar will be marked as “CreatedByApp.” The algorithm will furthermore set the entry to an action of update and add it to the EntriesToChange list.

FIG. 5 illustrates the process change algorithm 500, which may be used to process changes to a remote data store, and generally corresponds with the change act 340. The process change algorithm 500 takes the changes found (deletes, adds, and updates, for example), which are presently articulated in the EntriesToChange list, and brings the calendar entries of the POMP up to date. Accordingly, in a lock act 510, the device's calendar is “locked,” meaning the algorithm gains exclusive read/write access to the calendar. The lock act 510 is only executed in those POMP device models requiring it, such as Motorola® G20 class cell phones which presently include the RAZR® V3 and SLVR® L7. For some device models, the lock act 510 is needed to disallow any other changes while the POMP data is being updated by the algorithm. On still other models this action will also disallow viewing of the calendar on the POMP while it is being altered.

Next, in a marking deletes act 520, entries that should be deleted are marked. An alternative approach is to directly delete the entries from the handheld device. However, deletion may be a time consuming action, especially if the POMP is connected wirelessly. Thus, it is desirable to avoid any unnecessary deletes. Accordingly, an “optimization” may be performed in which a “delete” followed by a subsequent “add” may be replaced with an “update” to that entry designated for deletion. Therefore, in the marking deletes act 520, the entries that are to be deleted are marked so that they may be reused later.

Then, in an add entries act 530, the algorithm sends commands to the POMP to add new entries and update existing entries in the POMP's data store. Calendar entries marked in act 320 by the “CreatedByApp” flag are sent to the POMP with an indicator embedded within each entry. The indicator used is arbitrary but must match the indicator that is inspected for in the retrieve entries act 320.

Next, in a delete entries act 540, any entries previously marked for deletion that were not used for new entries in the proceeding act will be deleted from the POMP. An optional security act 550 is provided as a precautionary measure to prevent duplicate entries on the POMP and to safeguard the data integrity of the remote data store. Here, the calendar entries are searched and any duplicates are removed so that there is only one copy of each entry in the calendar. Then, in an unlock act 560, the POMP's calendar will be unlocked. Of course, as noted above, locking and unlocking may not be unnecessary for some models.

Though the invention has been described with respect to a specific preferred embodiment, many variations and modifications (including equivalents) will become apparent to those skilled in the art upon reading the present application. It is therefore the intention that the appended claims and their equivalents be interpreted as broadly as possible in view of the prior art to include all such variations and modifications.

I claim:

1. A method, comprising:
in a computer program running on a computing device, detecting a communication connection between the computing device and a plain old mobile phone (POMP);
the first computing device having a first contact-calendar program thereon, the first contact-calendar program having at least a first data store that stores contact-calendar data;
the POMP having a second contact-calendar program thereon, the second contact-calendar program having a second data store, the second data store having at least a first data entry therein;
the first data entry corresponding to a computing device data entry in the first data store;
retrieving from the POMP data entries comprising at least the first data entry;
inspecting the first data entry for a synchronization indicator; and
identifying the first data entry for an action based on the presence or absence of the synchronization indicator.

2. The method of claim 1 further comprising defining the first data entry as an entry to delete when the method locates the synchronization indicator in the second data entry, and the first data store does not have a data associated with the second data entry.

3. The method of claim 1 further comprising defining a second data entry in the first data store as an entry to add when there is no data entry in the second data store associated with the second data entry.

4. The method of claim 1 further comprising defining the first data entry as an entry to update when it is present in the first data store and present in the second data store, but there is no synchronization indicator.

5. The method of claim 1 wherein retrieving retrieves all data entries associated with the second contact-calendar program.

6. The method of claim 1 wherein the synchronization indicator comprises the characters: [B].
